(19) United States
(12) Patent Application Publication
(10) Pub. No.: US 2026/0238160 A1
(43) Pub. Date: Aug. 13, 2026

(54) SUPPORT STRUCTURES FOR SOLAR TRACKER SYSTEMS WITH INCREASED FLEXIBLITY

(71) Applicant: Nextpower LLC, Fremont, CA (US)

(72) Inventors: Emma Tam, Petaluma, CA (US); Charles Almy, Berkeley, CA (US)

(21) Appl. No.: 19/465,801

(22) Filed: Jan. 30, 2026

Related U.S. Application Data
(60) Provisional application No. 63/752,500, filed on Jan. 31, 2025.

(51) Int. Cl. H02S 20/32

(52) U.S. Cl. CPC H02S 20/32

(57) ABSTRACT

A solar tracker row for solar tracker systems includes a plurality of A-frame shaped supports coupled to underlying ground, arranged in a north-south row. A torque tube extends along the row and is rotatably supported on the plurality of A-frame shaped supports. A plurality of solar module assemblies is coupled to the torque tube. Each support includes a hollow shaft having a first section having a circular cross-section and a second section having a circular cross-section. The hollow shaft further includes a third section located between the first section and the second section having an oval cross-section, the oval cross-section defining a major axis and a minor axis. The major axis being oriented in an east-west direction and the minor axis being oriented in the north-south direction. The third section provides each support pier with greater flexibility in the north-south direction relative to the east-west direction.

### RELATED APPLICATIONS

This application claims the benefit of U.S. Provisional Patent Application No. 63/752,500, filed Jan. 31, 2025, the entire contents of which are incorporated herein by reference.

### TECHNICAL FIELD

This disclosure relates generally to solar power generation systems, and more particularly, to support structures for solar arrays within a solar tracking system.

### BACKGROUND

Solar panels can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. Accordingly, solar panels have great potential to benefit our nation, security, and human users. They can even diversify our energy requirements and reduce the world's dependence on oil and other potentially detrimental sources of energy.

Solar tracking systems can be used to dynamically orient a plurality of solar modules, for instance, by moving the solar modules throughout the course of a given day to track the movement of the sun and thereby increase the efficiency and productivity of the solar modules. However, because solar tracking systems apply motive force to move the solar modules, resulting forces can be imparted on the piles that support the movable solar modules. In addition, the solar modules can experience natural forces in the field, such as wind loads, which can create additional acting forces on the piles that support the movable solar modules.

Further, during operation of the solar tracker, thermal fluctuations occur daily and seasonably resulting in thermal expansion and contraction of the solar tracker components. In many instances, thermal expansion is not significant enough to impart noticeable forces on the components. However, the torque tubes of the solar trackers can span significant lengths, which results in noticeable expansion and contraction during daily and seasonal temperature fluctuations.

The thermal expansion and contraction of torque tubes can impart significant loads on the couplings and the piers supporting them. Axial forces due to expansion and contraction of the torque tube can cause the piers to deflect or otherwise deform to accommodate this axial movement by the torque tube. This deflection by the piers can cause misalignment of the couplings with respect to the torque tubes, which can cause increased friction or binding of the torque tube as the torque tube is rotated within the couplings. This binding or increased friction increases the amount of force required to rotate the torque tube, which in turn, imparts increased load on the actuators or motors effectuating the rotation, and in some instances can cause the torque tube to twist along its length, causing some solar panels to rotate more or less than other solar panels along the length of the torque tube. The present disclosure seeks to address the shortcomings of prior tracker systems.

### SUMMARY

In general, the present disclosure relates to support structures for solar arrays within a solar tracking system. In one example, a solar tracker row may include a plurality of A-frame shaped supports coupled to underlying ground, the plurality of A-frame shaped supports arranged in a north-south row, each A-frame shaped support defining a central longitudinal axis. a torque tube extending along the north-south row and rotatably supported on the plurality of A-frame shaped supports, and a plurality of solar module assemblies coupled to the torque tube. Each A-frame shaped support may include at least one tubular hollow shaft, the hollow shaft having a first section having a first circular cross-section and a second section having a second circular cross-section, the hollow shaft having a third section having an oval cross-section, the oval cross-section defining a major axis and a minor axis. The major axis may be oriented in an east-west direction and the minor axis may be oriented in the north-south direction. The third section may be located between the first section and the second section. The circular cross-sections and the oval cross-section being taken normal to the central longitudinal axis, the third section providing each A-frame shaped support with greater flexibility in the north-south direction relative to the east-west direction.

Additionally or alternatively, the hollow shaft may have a first transition section and a second transition section, wherein the first circular cross-section of the first section may gradually transition through the first transition section into the oval cross-section of the third section, and the oval cross-section of the third section may gradually transition through the second transition section into the second circular cross-section of the second section.

Additionally or alternatively, the first transition section may have an oval cross-section have a first transition section major axis and a first transition minor axis, the first transition section major axis being shorter than the third section major axis.

Additionally or alternatively, the first transition section may have an oval cross-section have a first transition section major axis and a first transition minor axis, the first transition section minor axis being longer than the third section minor axis.

Additionally or alternatively, each A-frame shaped support may form part of a truss, the truss including the at least one tubular, hollow shaft and a second tubular, hollow shaft embedded in the ground, arranged side-by-side in an east-west orientation, and interconnected by a truss cap.

Additionally or alternatively, each A-frame shaped support may be formed of a ground screw and a hollow upper leg, the first section, second section, and third section being sections of the hollow upper leg.

Additionally or alternatively, the third section may have a uniform cross-section along the central longitudinal axis.

Additionally or alternatively, the third section major axis may be larger than a diameter of the first circular cross-section of the first section.

Additionally or alternatively, the third section minor axis may be shorter than a diameter of the first circular cross-section of the first section.

Additionally or alternatively, each A-frame shaped support may extend a pier height above the ground, and wherein the third section is located in the upper third portion of the A-frame shaped support.

Additionally or alternatively, the first section, second section, and third section together may define a flexible section of each A-frame shaped support, wherein each A-frame shaped support may contain two or more flexible sections along the central longitudinal axis of each A-frame shaped support.

In another example, a truss for a solar tracker system may include a first support pier and a second support pier embedded in the ground, arranged side-by-side in an east-west orientation, and interconnected by a truss cap, thereby forming an A-frame shaped support. The first support pier and the second support pier may each include a hollow shaft, the hollow shaft having a first section having a first circular cross-section and a second section having a second circular cross-section. The hollow shaft having a third section having an oval cross-section, and the oval cross-section defining a major axis and a minor axis. The major axis being oriented in an east-west direction and the minor axis being oriented in the north-south direction and the third section being located between the first section and the second section. The circular cross-sections and the oval cross-section being taken normal to the central longitudinal axis, the third section providing each support pier with greater flexibility in the north-south direction relative to the east-west direction.

Additionally or alternatively, the hollow shaft may have a first transition section and a second transition section, wherein the first circular cross-section of the first section may gradually transition through the first transition section into the oval cross-section of the third section, and the oval cross-section of the third section may gradually transition through the second transition section into the second circular cross-section of the second section.

Additionally or alternatively, the first section, second section, and third section together may define a flexible section of each support pier, wherein each support pier may contain two or more flexible sections along the central longitudinal axis of each support pier.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3 is a front view of a portion of an example solar module supported by an example truss foundation;

FIG. 4A is an example screw anchor usable with various embodiments of the present disclosure;

FIG. 4B is a detailed view of a lead-in thread form of the screw anchor, as in FIG. 4A;

FIG. 5 is front view of an example truss support in accordance with the present disclosure;

FIG. 6A is a side view of a first support pier of the example truss support of FIG. 5;

FIG. 6B is an enlarged view of a top portion of the first support pier, shown in Circle 6 of FIG. 6A;

FIG. 7A is an enlarged view of a top portion of the example truss support as in FIG. 5;

FIG. 7B is a cross-sectional view of the top portion of the example truss support, as in FIG. 7A, taken at line 7;

FIG. 8A is a perspective view of a hollow shaft of the first support pier of the example truss support, as in FIG. 5;

FIG. 8B is an enlarged portion of the hollow shaft of the first support pier shown in Circle 8 of FIG. 8A;

FIG. 8C is a cross-sectional view of a first section of the hollow shaft, as in FIG. 8B, taken at line 8C;

FIG. 8D is a cross-sectional view of a third section of the hollow shaft, as in FIG. 8B, taken at line 8D;

FIG. 8E is a cross-sectional view of a second section of the hollow shaft, as in FIG. 8B, taken at line 8E;

FIG. 9A is a front view of an example truss cap usable with various embodiments of the present disclosure;

FIG. 9B is a front view an example screw anchor usable with various embodiments of the present disclosure;

FIG. 9C is a front perspective view of an example collar usable with various embodiments of the present disclosure;

FIG. 9D is a front perspective view on the screw anchor and the collar as in FIGS. 9B to 9C, usable with various embodiments of the present disclosure;

FIG. 10 is front view of an example truss support in accordance with the present disclosure;

FIG. 11A is a side view of a first support pier of the example truss support of FIG. 10;

FIG. 11B is an enlarged view of a top portion of the first support pier, shown in Circle 11 of FIG. 11A;

FIG. 12A is an enlarged view of a top portion of the example truss support as in FIG. 10A;

FIG. 12B is a cross-sectional view of the top portion of the example truss support, as in FIG. 12A, taken at line 12;

FIG. 13A is a perspective view of a hollow shaft of the first support pier of the example truss support, as in FIG. 10;

FIG. 13B is a cross-sectional view of a first section of the hollow shaft, as in FIG. 13A, taken at line 13B;

FIG. 13C is a cross-sectional view of a first transitional section of the hollow shaft, as in FIG. 13A, taken at line 13C;

FIG. 13D is a cross-sectional view of a third section of the hollow shaft, as in FIG. 13A, taken at line 13D;

FIG. 13E is a cross-sectional view of a second transitional section of the hollow shaft, as in FIG. 13A, taken at line 13E; and FIG. 13F is a cross-sectional view of a second section of the hollow shaft, as in FIG. 13A, taken at line 13F.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar tracker supports configured to facilitate improved structural stability for solar tracking systems. Certain embodiments disclosed herein can improve solar tracking system structural stability while increasing the efficiency of solar tracking foundation installation and reducing costs (e.g., foundation and/or support material costs) associated with solar tracker foundations and supports.

During operation of solar trackers, thermal fluctuations occur daily and seasonably resulting in thermal expansion and contraction of the solar tracker components. In many instances, thermal expansion is not significant enough to impart noticeable forces on the components. However, the torque tubes of the solar trackers can span significant lengths, which results in noticeable expansion and contraction during daily and seasonal temperature fluctuations.

The thermal expansion and contraction of torque tubes can impart substantial axial loads on the support structures. The torque tubes of the solar tracker are rotatably supported on the piers by a coupling. These couplings enable the torque tube to rotate about its longitudinal axis and in many embodiments, enable the torque tube to axially slide within the coupling to accommodate thermal expansion and contraction of the torque tube. Axial movement of the torque tube can impart significant loads on the couplings and the piers supporting them. Axial forces due to expansion and contraction of the torque tube can cause the piers to deflect or otherwise deform to accommodate this axial movement by the torque tube. This deflection by the piers can cause misalignment of the couplings with respect to the torque tubes, which can cause increased friction or binding of the torque tube as the torque tube is rotated within the couplings. This binding or increased friction increases the amount of force required to rotate the torque tube, which in turn, imparts increased load on the actuators or motors effectuating the rotation, and in some instances can cause the torque tube to twist along its length, causing some solar panels to rotate more or less than other solar panels along the length of the torque tube. Embodiments herein may include piers and/or truss supports designed to increase flexibility in a north-south direction, aligning with the length of the torque tube, to accommodate deflection caused by thermal expansion. In such cases, the piers and/or truss supports may flex with the torque tube thereby preventing deformation due to axial forces via thermal expansion placed upon the torque tube.

Solar tracking systems may be used to dynamically orient a plurality of solar modules, for instance, by moving the solar modules throughout the course of a given day to track the movement of the sun (e.g., an east-west direction) and thereby increase the efficiency and productivity of the solar modules. However, because solar tracking systems apply motive force to move the solar modules, resulting forces can be imparted on the piles that support the movable solar modules. In addition, the solar modules can experience natural forces in the field, such as wind loads, which can create additional acting forces on the piles that support the movable solar modules. Embodiments disclosed herein may include piers and/or truss supports designed to increase the strength of the piers and/or truss supports in an east-west direction, as the solar modules track the movement of the sun. Further, the piers and/or truss supports disclosed herein may be designed to increase flexibility in a north-south direction, aligning with the length of the torque tube, to accommodate natural forces in the field, such as wind loads. In such cases, the piers and/or truss supports may flex with the wind thereby preventing deformation and/or damage due to forces placed upon the piers and/or truss supports.

Embodiments disclosed herein may be formed via a hydroforming process. Hydroforming may be a material-efficient process as it deforms the material rather than cutting it, minimizing waste and ultimately reducing costs. Hydroforming solar tracker components, such as those described herein, may offer superior design flexibility, such as, allowing for intricate shapes that create more streamlined and integrated solutions. Additionally, the resulting structures tend to be lighter, improving overall tracker efficiency and reducing foundation requirements. The stress distribution in hydroformed parts typically leads to better structural performance compared to welded joints, which can be weaker due to heat-affected zones. While hydroforming may entail higher initial setup costs, the reduction in material waste and labor can result in lower overall production costs, especially in high-volume applications.

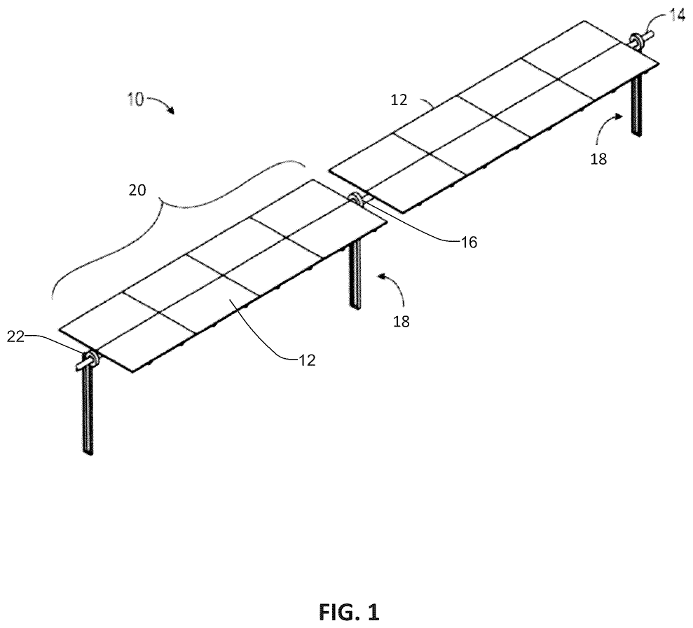

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

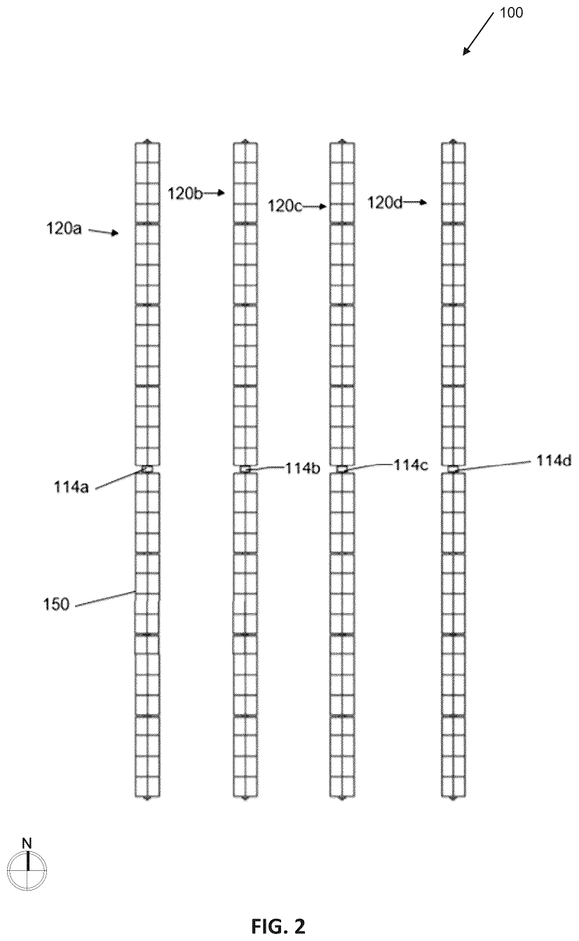

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

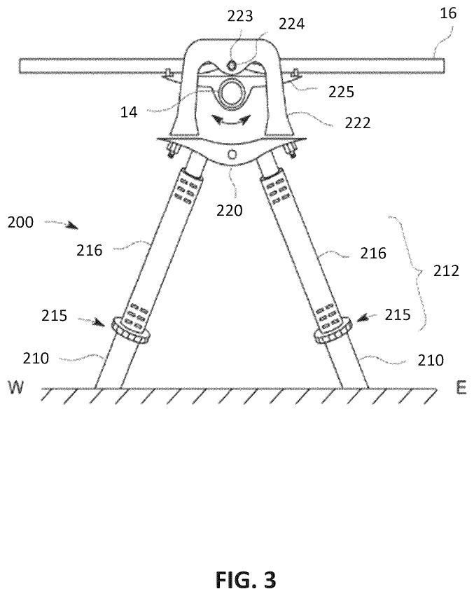

FIG. 3 is a front view of a portion of the solar module 12 supported by an example truss foundation 200. The truss foundation 200 may include a pair of adjacent screw anchors 211 that have been driven into supporting ground at angles to one another on the East and West sides of an intended North-South line of a tracker row. Once anchors 211 reach their target embedment depth, driving stops and truss cap or adapter 220 is held in place by a jig on the driving machine at the correct location to insure alignment with other truss caps or adapters in the same row. Then, upper legs 216 are sleeved over driving collars 215 of each anchor and respective connecting portions 221 of the truss cap 220 to complete each truss leg 216. As shown in FIG. 3, truss cap 220 provides a pair of spaced-apart pedestals that support the opposing feet of a bearing housing assembly (BHA) 222. As shown, BHA 222 is a cardioid-shaped hoop with bearing 223 proximate to the cusp. It should be appreciated that other variants are possible as long as the bearing location enables the torque tube to be suspended from a bearing pin rather than rotating about its own axis. Bearing pin 224 is received within bearing 223 and extends out of both sides of BHA 222. A torque tube module bracket such as bracket 225 is suspended from either side of bearing pin 224. Brackets 225 support the torque tube 14 and attach to the frame of at least one adjacent photovoltaic module or solar panel 12. In this type of tracker system, the drive motor's drive axis is aligned with bearing pin 224 rather than the torque tube 14 so that as the motor's output shaft rotates, the torque tube 14 swings through an arc that is bounded on either side by the BHA 222. This may be accomplished by a bend in the torque tube 14 on both sides of the drive motor.

As shown in the FIG. 3, upper legs 216 are joined to adapters 220 by sleeving the open end of each leg over respective connecting portions protecting away from the adapter. Then, crimps are formed over the overlapping portion of each upper leg 216 to lock the adapters into place. Crimps are also formed at the lower end of each upper leg 216 where it overlaps with the collar 215. In various embodiments, the screw anchor driving machine may include a jig or other device that orients the adapter or truss cap so that it is level and aligned with a laser line to be at the at the same Y (East-West) position as every other adapter in the current row so that the truss foundation 200 can be constructed in a fast, precise and repeatable manner. In various embodiments, once the adapter or truss cap 220 has been properly aligned, upper legs 216 may be crimped at each end, that is, at the areas of overlap with screw anchors 211 and with truss cap or adapter 220, thereby forming a rigid A-frame shaped support. In various embodiments, assembling the truss foundation 200 at the time the screw anchors are driven will obviate the need for later alignment steps, such as when the tracker components are installed.

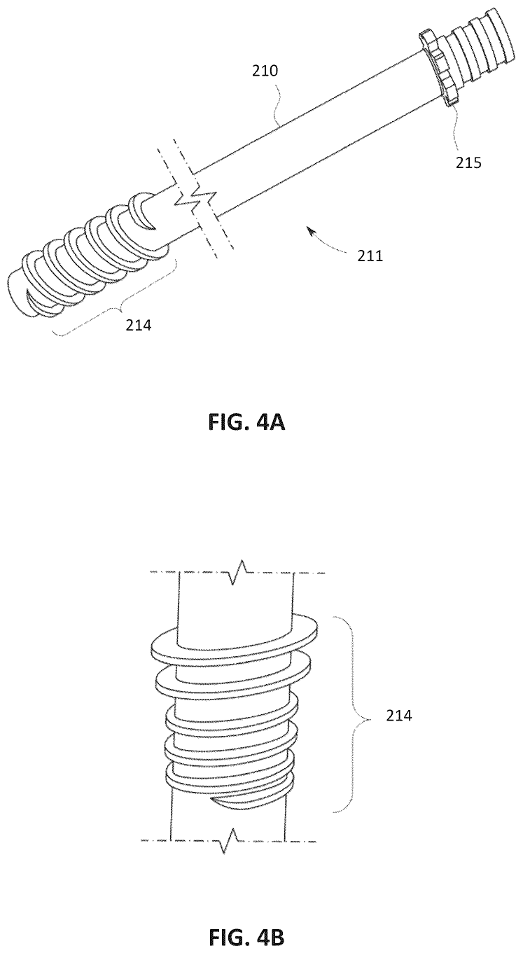

FIG. 4A is an example screw anchor 211 and FIG. 4B is a detailed view of a lead-in thread form 214 of the screw anchor 211, as in FIG. 4A. The screw anchor 211 is shown partially shown in FIG. 3. The screw anchor 211 may consist of a hollow, substantially uniform diameter rounded shaft 210 that is open at both ends with external threads 214 at one end and a driving collar 215 at the other. In various embodiments, threads 214 may have a tapered profile, as seen for example, in FIG. 4B, so that their outside diameter increases moving up the shaft to create a lead-in. A taper such as this may help keep it on path while driving and assist when driving into hard soils, caliche and even rock. The threads may also, in various embodiments, be tilted slightly upwards, that is, towards collar 215 to provide additional resistance to pull out. The length of screw anchor 211 may be variable depending on the desired depth of embedment (e.g., 1-2 meters). In the context of foundations for single-axis trackers and other axial solar arrays, embedment depth may be dictated by soil type, grade of land, torque tube height, and tracker type, among other factors. The inside diameter of the shaft 210 may be between two and half and three inches and the thickness on the order of a few millimeters. It may be formed from galvanized alloy steel or other suitable material. In some cases, it may be coated with one or more additional anti-corrosion coatings such as fusion bonded epoxy, polyurethane, or acrylic, among others. Driving collar 215 may be a separate cast structure welded on to the upper end of shaft 210 or, alternatively, may be stamped, pressed, or otherwise formed in the upper end. Threads 214 may be welded to the outside of shaft 210 at the lower end, may be attached with bent tabs or, in some cases may even be stamped into the lower end. In some cases, the threads 214 may be hydroformed from the shaft 210. The threads 214 may enable the screw anchor 211 be driven into supporting ground with a combination of torque and downforce. The screw anchor's 211 open end allows a drill or other tool to be extended through it while the anchor is being driven into the ground to enable it to go through dense soil, rocks or other strata that might refuse the anchor 211 by itself.

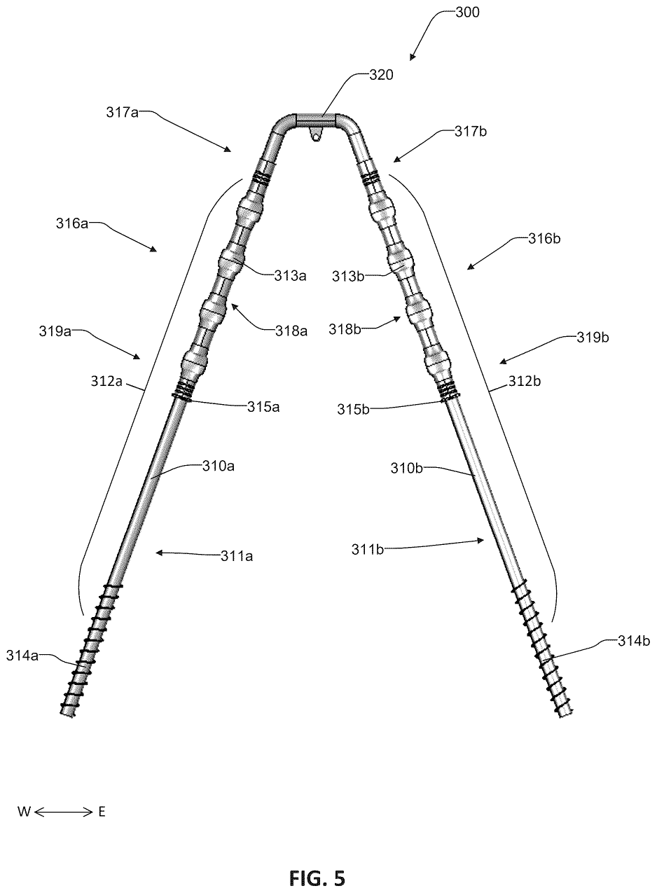

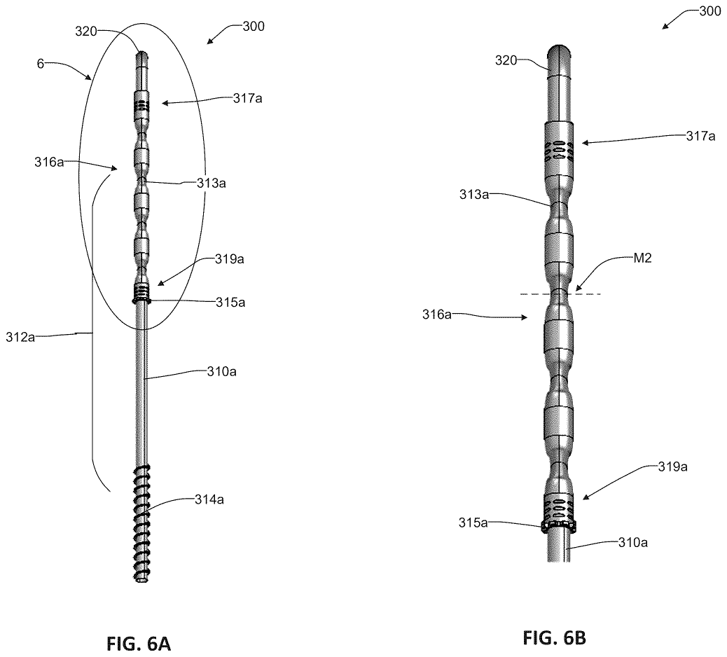

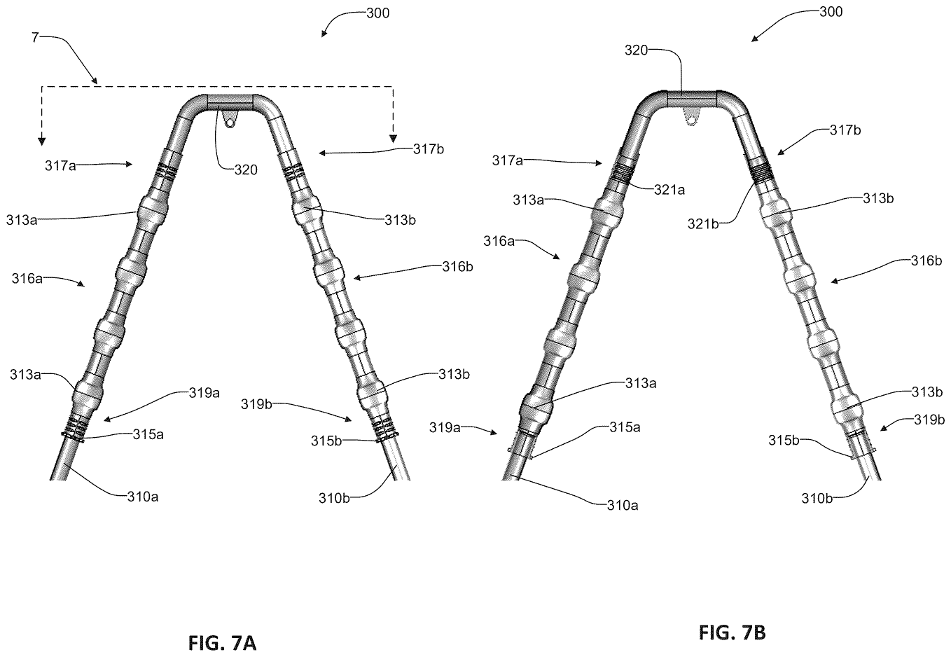

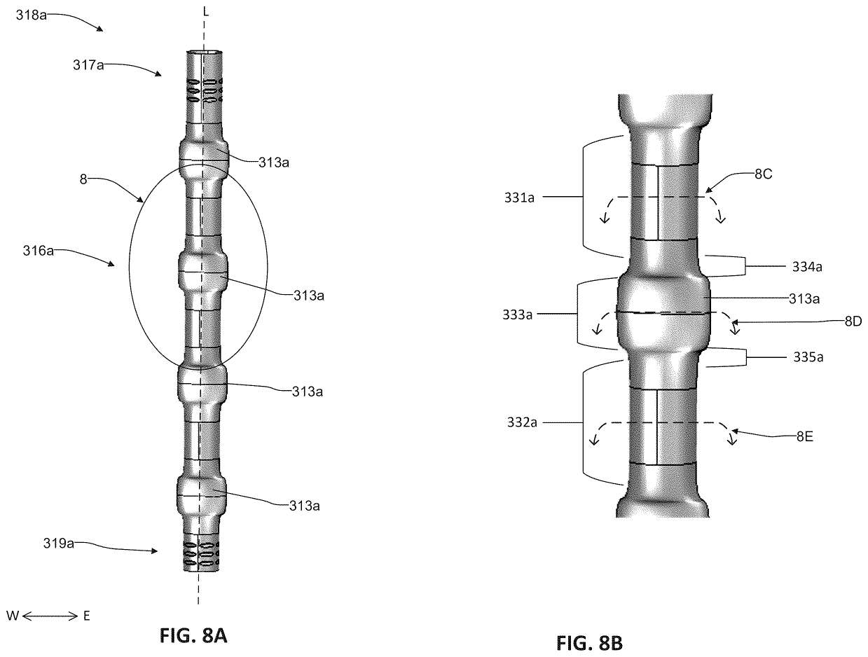

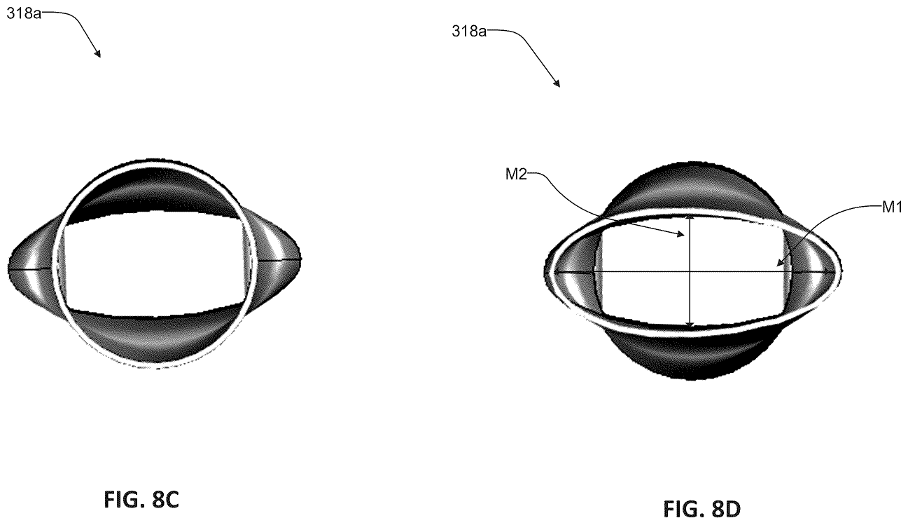

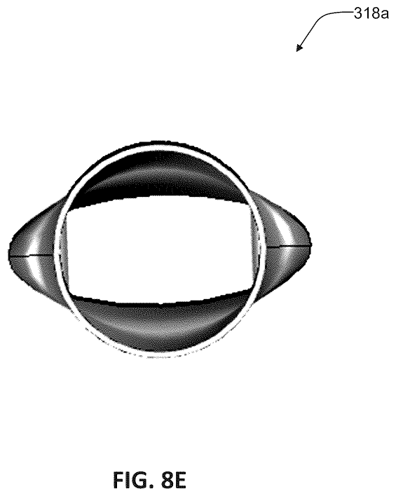

FIGS. 5 to 8E illustrate an example truss support 300 in accordance with the disclosure. FIG. 5 is front view of the example truss support 300, FIG. 6A is a side view of a first support pier 312a of the example truss support 300, FIG. 6B is an enlarged view of an upper leg 318a of the first support pier 312a, as in Circle 6 of FIG. 6A, FIG. 7A is an enlarged view of a top portion of the example truss support 300, FIG. 7B is a cross-sectional view of the top portion of the example truss support 300, as in FIG. 7A, taken at line 7, FIG. 8A is a perspective view of the upper leg 318a of the first support pier 312a of the example truss support 300, FIG. 8B is an enlarged portion of the upper leg 318a of the first support pier 312a shown in Circle 8 of FIG. 8A, FIG. 8C is a cross-sectional view of a first section of the upper leg 318a, as in FIG. 8B, FIG. 8D is a cross-sectional view of a third section of the upper leg 318a as in FIG. 8B, and FIG. 8E is a cross-sectional view of a second section of the upper leg 318a as in FIG. 8B, taken at line 8E.

The truss support 300 (generally referred to herein as truss 300) may include a first support pier 312a and a second support pier 312b. In some examples, the truss support 300 may be considered an A-frame shaped support. The truss support 300 (e.g., A-frame shaped support) may include at least one tubular, hollow shaft. For example, referring to the first support pier 312a, the first support pier 312a may include a hollow, metal shaft coupled to a screw anchor 311a. The screw anchor 311a, 311b may be an example of the screw anchor 211 as in FIGS. 4A to 4B. The hollow, metal shaft may be generally referred to as an upper leg 318a. The screw anchor 311a may consist of a hollow, substantially uniform diameter rounded shaft 310a that is open at both ends with external threads 314a at one end and a driving collar 315a at the other. In various embodiments, threads 314a may have a tapered profile so that their outside diameter increases moving up the shaft to create a lead-in. A taper such as this may help keep it on path while driving and assist when driving into hard soils, caliche and even rock. The threads 314a may also, in various embodiments, be tilted slightly upwards, that is, towards the collar 315a to provide additional resistance to pull out. The length of screw anchor 311a may be variable depending on the desired depth of embedment (e.g., 1-2 meters). While it is illustrated that the screw anchor 311a may include a hollow metal tube, it may be contemplated that other shapes, materials, and cross-sections may be used.

The upper leg 318a may include a first end 317a, a second end 319a, and a central portion 316a. The central portion 316a may include a first section 331a having a first circular cross-section and a second section 332a having a second circular cross-section. The central portion 316a of the upper leg 318a may further include a third section 333a having an oval cross-section which may be located between the first section 331a and the second section 332a, as shown in further detail with reference to FIGS. 8A to 8E. Together, the first section 331a, the second section 332a, and the third section 333a may make up various sections of the hollow, upper leg 318a. In some examples, as shown in FIGS. 8A to 8E, the third section 333a may include a uniform cross-section along the central longitudinal axis L of the support pier 312a. The oval cross-section may define a major axis M₁ (shown in FIG. 8D) and a minor axis M₂ (shown in FIG. 8D). The major axis M₁ may be oriented in an east-west direction and the minor axis M₂ may be oriented in the north-south direction. In some examples, the third section 333a minor axis M₂ may be smaller than a diameter of the first circular cross-section of the first section 331a and/or the second circular cross-section of the second section 332a. As will be appreciated, since the third section 333a minor axis M₂ is oriented generally in the north-south direction, the third section 333a of the upper leg 318a has greater flexibility in the north-south direction than the first section 331a and the second section 332a. The greater flexibility of the third section 333a aids in accommodating thermal expansion of the torque tube (e.g., torque tube 14). Similarly, as the third section 333a major axis M₁ is oriented generally in the east-west direction, the third section 333a will have a great rigidity in the east-west direction than the first section 331a and/or the second section 332a of the upper leg 318a The greater rigidity in the east-west direction aids in providing strength of the truss support 300 in the east-west direction, which is often the direction of greater force from wind as the panels (e.g., solar panels 12) are pivoting in an east-west direction during normal tracking. It will be appreciated that the first and second circular cross-sections and the oval cross-sections described herein are being taken normal to a central longitudinal axis L of the upper leg 318a.

As shown in FIGS. 8A to 8E, the third section 333a of the upper leg 318a may include a plurality of oval sections 313a. The plurality of oval sections 313a may include one, two, three, four, five, ten, fifteen, or any number oval sections 313a as desired so as to allow for the desired amount of deflection of the truss support 300. The first section 331a, the second section 332a, and the third section 333a together may define a flexible section of the first support pier 312a. In some examples, the third section 333a may provide the first support pier 312a with greater flexibility in the north-south direction than the east-west direction. While the third section 333a may include the oval sections 313a having oval cross-sections, the first section 331a and the second section 332a may include the first and second circular cross-sections, respectively, to permit the upper leg 318a to be coupled to the screw anchor 311a (e.g., at the second end 319a) and a truss cap 320 (at the first end 317a). The second end 319a may be coupled to the screw anchor 311a by overlapping the collar 315a and crimping the second end 319a of the upper leg 318a around the collar 315a.

As shown in FIGS. 8B to 8E, the hollow, upper leg 318a may include a first transitional section 334a and a second transitional section 335a. The first circular cross-section of the first section 331a may gradually transition through the first transitional section 334a into an oval cross-section, indicated by reference numeral 313a, of the third section 333a. In some examples, the oval cross-section of the third section 333a may gradually transition through the second transitional section 335a into the second circular cross-section of the second section 332a. In some examples, the first transitional section 334a may include a semi-oval cross-section, in some examples the first transitional section 334a may include a semi-circular cross-section, in some examples the first transitional section 334a may include a circular cross-section, and in other examples, the first transitional section 334a may include an oval cross-section. In some examples, the second transitional section 335a may include a semi-oval cross-section, in some examples the second transitional section 335a may include a semi-circular cross-section, in some examples the second transitional section 335a may include a circular cross-section, and in other examples, the second transitional section 335a may include an oval cross-section. In some examples, a first transition section major axis M₃ may be shorter than the third section 333a major axis M₁. In some examples, the second transition section major axis M₄ may be shorter than the third section 333a major axis M₁. In some examples, the first transition section major axis may be greater than the third section 333a minor axis M₂. In some examples, the second transition section major axis may be greater than the third section 333a minor axis M₂.

The second support pier 312b may be the same as the first support pier 312a. The second support pier 312b may include a hollow, metal shaft coupled to a screw anchor 311b. The hollow, metal shaft may be referred to as a hollow upper leg 318b. The screw anchor 311b may consist of a hollow, substantially uniform diameter rounded shaft 310b that is open at both ends with external threads 314b at one end and a driving collar 315b at the other. In various embodiments, threads 314b may have a tapered profile so that their outside diameter increases moving up the shaft to create a lead-in. A taper such as this may help keep it on path while driving and assist when driving into hard soils, caliche and even rock. The threads 314b may also, in various embodiments, be tilted slightly upwards, that is, towards the collar 315b to provide additional resistance to pull out. The length of screw anchor 311b may be variable depending on the desired depth of embedment (e.g., 1-2 meters). While it is illustrated that the screw anchor 311b may include a hollow metal tube, it may be contemplated that other shapes, materials, and cross-sections may be used.

The upper leg 318b may include a first end 317b, a second end 319b, and a central portion 316b. The upper leg 318b may include a first section 331b having a first circular cross-section and a second section 332b having a second circular cross-section. The upper leg 318b may further include a third section 333b having an oval cross-section which may be located between the first section 331b and the second section 332b. While the upper leg 318b of the second support pier 312b is not explicitly shown in enlarged and/or cross-sectional views, it will be appreciated that the enlarged and/or cross-sectional views of the upper leg 318a of the first support pier 312a further apply to the upper leg 318b of the second support pier 312b.

In the example shown in FIGS. 5 to 8E, each of the first support pier 312a and the second support pier 312b contains two or more flexible sections along the central longitudinal axis L of each support pier 312a, 312b, e.g., the oval sections 313a, 313b, respectively. In some examples, the third section 333a, 333b may be located in the upper third portion of the support pier 312a, 312b. Further, as shown in FIGS. 5, 7A, and 7B, each support pier 312a, 312b forms part of the truss 300. The truss 300 may include the first support pier 312a and the second support pier 312b embedded in the ground, arranged side-by-side in an east-west orientation, and interconnected by the truss cap 320, thereby forming an A-frame shaped support. As shown, the first support pier 312a and the second support pier 312b are joined to the truss cap 320 by sleeving an open end of each upper leg 318a, 318b over respective connecting portions 321a, 321b of the truss cap 320. Crimps are then formed over the overlapping portion of each upper leg 318a, 318b to lock the truss cap 320 into place. Crimps are also formed at the lower end of each upper leg 318a, 318b where it overlaps with the collars 315a, 315b, respectively. In various embodiments, a screw anchor driving machine may include a jig or other device that orients the truss cap 320 so that it is level and aligned with a laser line to be at the at the same Y (East-West) and Z (up-down) position as every other truss cap 320 in a current solar tracker row (e.g., row 120) so that the truss support 300 can be constructed in a fast, precise and repeatable manner. In various embodiments, once the truss cap 320 has been properly aligned, upper legs 318a, 318b may be crimped at each end, that is, at the areas of overlap with screw anchors 311a, 311b and with truss cap 320, thereby forming a rigid A-frame structure. In some examples, each support pier 312a, 312b extends a pier height above the ground, as illustrated in FIG. 3. In various embodiments, assembling the truss support 300 at the time the screw anchors 311a, 311b are driven will obviate the need for later alignment steps, such as when the tracker components are installed.

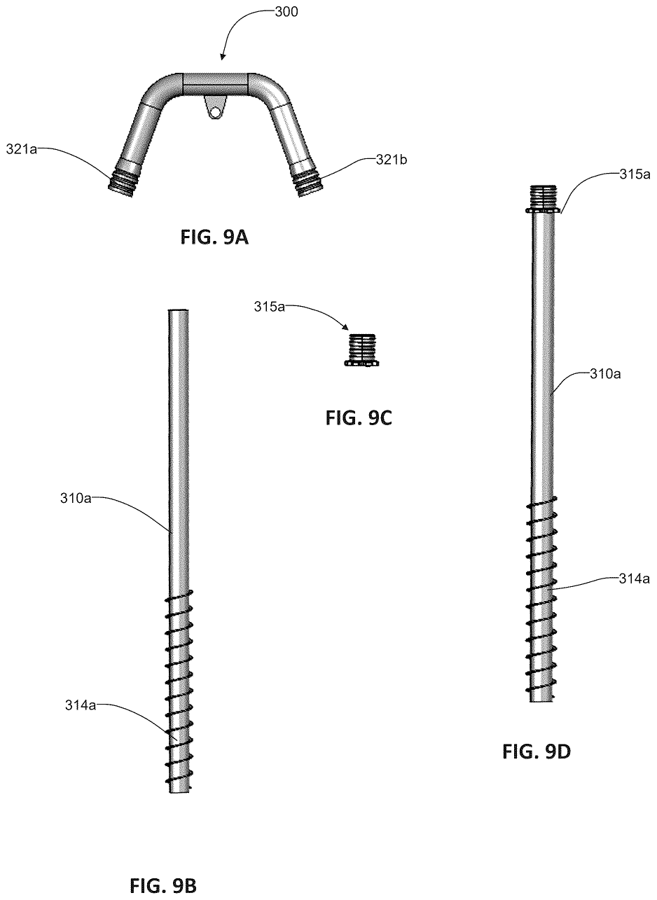

FIG. 9A is a front view of the truss cap 320 usable with various embodiments of the present disclosure. As shown the truss cap 320 may include connecting portions 321a, 321b. The connecting portions 321a, 321b may be configured to be coupled with the upper legs 318a, 318b, 418a, 418b described herein. FIG. 9B is a front view of the screw anchor 311a (screw anchor 311b the same as screw anchor 311a) usable with various embodiments of the present disclosure, FIG. 9C is a front perspective view of the example collar 315a (collar 315b the same as collar 315a) usable with various embodiments of the present disclosure, and FIG. 9D is a front perspective view of the screw anchor 311a and the collar 315a as in FIGS. 9B to 9C, usable with various embodiments of the present disclosure.

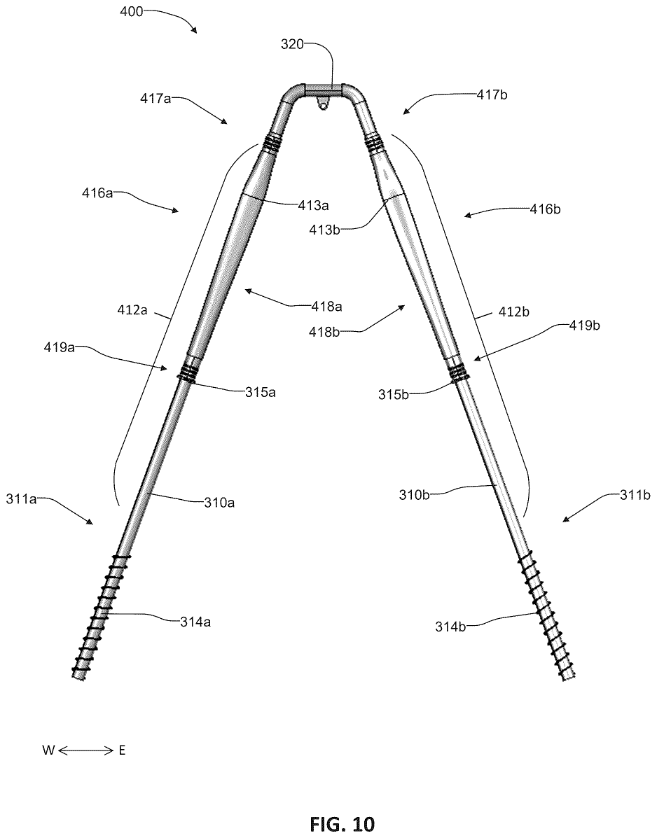

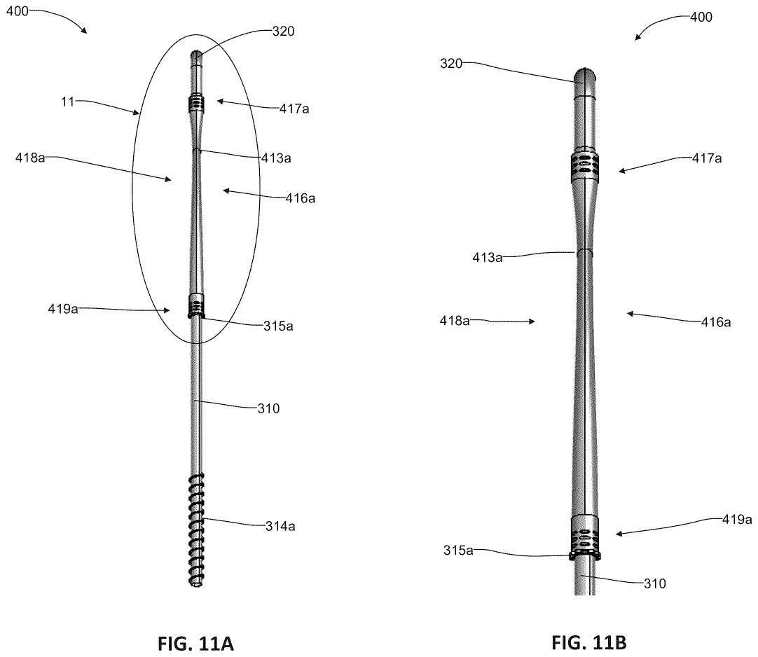

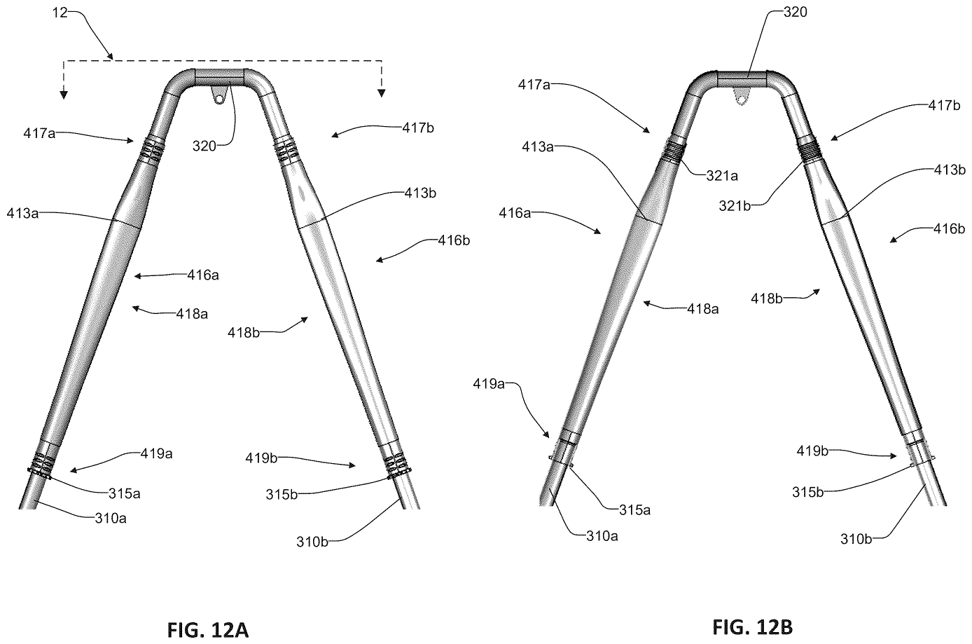

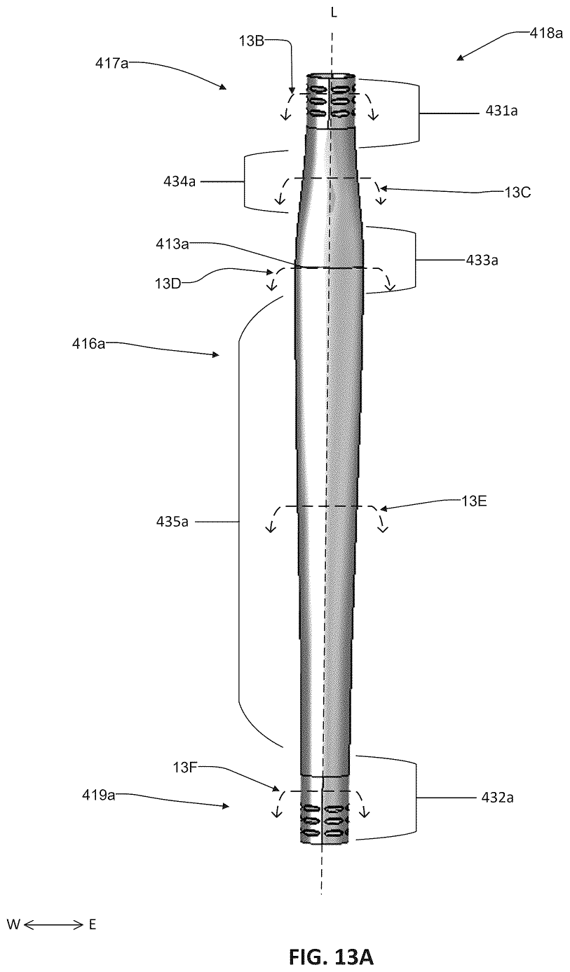

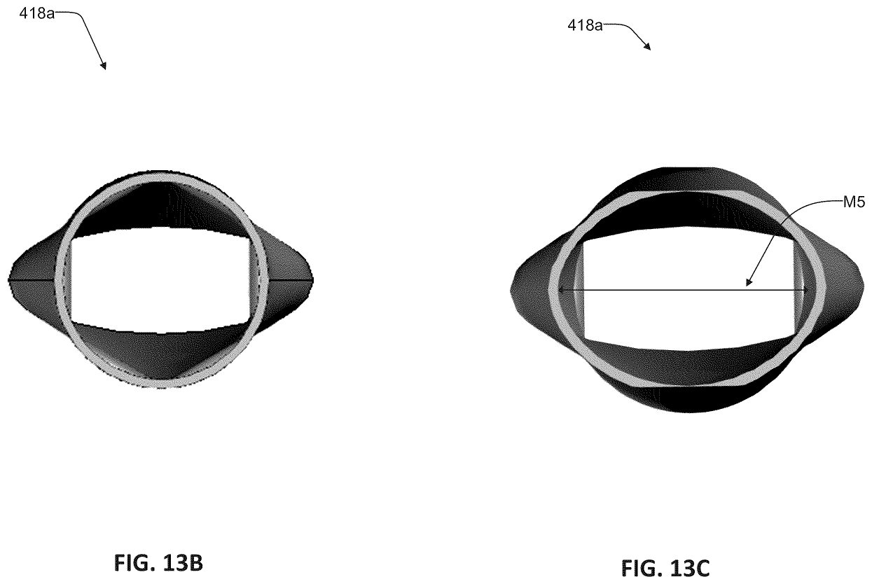

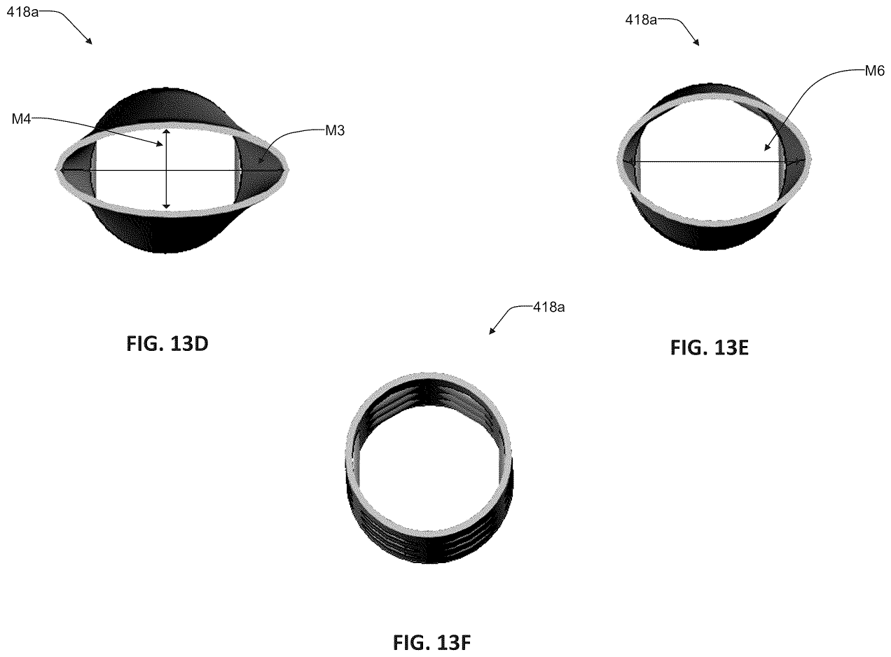

FIG. 10 to 13F illustrate an example truss support 400 in accordance with the disclosure. FIG. 10A is front view of the truss support 400 in accordance with the present disclosure, FIG. 11A is a side view of a first support pier 412a of the truss support 400, FIG. 11B is an enlarged view of a top portion of the first support pier 412a, as in Circle 11 of FIG. 11A, FIG. 12A is an enlarged view of a top portion of the truss support 400, FIG. 12B is a cross-sectional view of the top portion of the truss support 400, as in FIG. 12A, taken at line 12, FIG. 13A is a perspective view of an upper leg 418a of the first support pier 412a of the example truss support 400, as in FIG. 10, FIG. 13B is a cross-sectional view of a first section 431a of the upper leg 418a as in FIG. 13A, taken at line 13B, FIG. 13C is a cross-sectional view of a first transitional section 434a of the upper leg 418a, as in FIG. 13A, taken at line 13C, FIG. 13D is a cross-sectional view of a third section 433a of the upper leg 418a, as in FIG. 13A, taken at line 13D, FIG. 13E is a cross-sectional view of a second transitional section 435a of the upper leg 418a, as in FIG. 13A, taken at line 13E, and FIG. 13F is a cross-sectional view of a second section 432a of the upper leg 418a, as in FIG. 13A, taken at line 13F.

The truss support 400 is like the truss support 300 except for the shape of the upper leg 418a and the upper leg 418b. Referring to the first support pier 412a, the first support pier 412a may include a hollow, metal shaft coupled to the screw anchor 311a. The hollow, metal shaft may be generally referred to as an upper leg 418a. The screw anchor 311a is described above with reference to FIGS. 5 to 8E.

The upper leg 418a may include a first end 417a, a second end 419a, and a central portion 416a. The central portion 416a may include a first section 431a having a first circular cross-section and a second section 432a having a second circular cross-section. Together, the first section 431a, the second section 432a, and the third section 433a may make up various sections of the hollow, upper leg 418a. The central portion 416a of the upper leg 418a may further include a third section 433a having an oval cross-section which may be located between the first section 431a and the second section 432a, as shown in further detail with reference to FIGS. 13A to 13F. The third section 433a may include a uniform cross-section along the central longitudinal axis L of the support pier 412a. The oval cross-section may define a major axis M₃ (shown in FIG. 13D) and a minor axis M₄ (shown in FIG. 13D). The major axis M₃ may be oriented in an east-west direction and the minor axis M₄ may be oriented in the north-south direction. In some examples, the third section 433a minor axis M₄ may be smaller than a diameter of the first circular cross-section of the first section 431a and/or the second circular cross-section of the second section 432a. As will be appreciated, since the third section 433a minor axis M₄ is oriented generally in the north-south direction, the third section 433a of the upper leg 418a has greater flexibility in the north-south direction than the first section 431a and the second section 432a. The greater flexibility of the third section 433a aids in accommodating thermal expansion of the torque tube (e.g., torque tube 14). Similarly, as the third section 433a major axis M₃ is oriented generally in the east-west direction, the third section 433a will have a great rigidity in the east-west direction than the first section 431a and/or the second section 432a of the upper leg 418a The greater rigidity in the east-west direction aids in providing strength of the truss support 400 in the east-west direction, which is often the direction of greater force from wind as the panels (e.g., solar panels 12) are pivoting in an east-west direction during normal tracking. It will be appreciated that the circular cross-sections and the oval cross-sections described herein are being taken normal to a central longitudinal axis L of the upper leg 418a.

As shown in FIGS. 13A to 13E, the hollow shaft, or the upper leg 418a may include a first transitional section 434a and a second transitional section 435a. While the upper leg 418b of the second support pier 412b is not explicitly shown in enlarged and/or cross-sectional views, it will be appreciated that the enlarged and/or cross-sectional views of the upper leg 418a of the first support pier 412a further apply to the upper leg 418b of the second support pier 412b.

As shown in FIGS. 13A to 13E, the first circular cross-section of the first section 431a may gradually transition through the first transitional section 434a into an oval cross-section, indicated by reference numeral 413a, of the third section 433a. In some examples, the oval cross-section 413a of the third section 433a may gradually transition through the second transitional section 435a into the second circular cross-section of the second section 432a. In some examples, the oval cross-section 413a of the third section 433a may gradually transition through the second transitional section 435a into the second circular cross-section of the second section 432a. In some examples, the first transitional section 434a may include a semi-oval cross-section, in some examples the first transitional section 434a may include a semi-circular cross-section, in some examples the first transitional section 434a may include a circular cross-section, and in other examples, the first transitional section 434a may include an oval cross-section. In some examples, the second transitional section 435a may include a semi-oval cross-section, in some examples the second transitional section 435a may include a semi-circular cross-section, in some examples the second transitional section 435a may include a circular cross-section, and in other examples, the second transitional section 435a may include an oval cross-section. In some examples, a first transition section major axis M₅ may be shorter than the third section 433a major axis M₃. In some examples, the second transition section major axis M₆ may be shorter than the third section 433a major axis M₃. In some examples, the first transition section major axis M₅ may be greater than the third section 433a minor axis M₄. In some examples, the second transition section major axis M₆ may be greater than the third section 433a minor axis M₄. In some examples, the first transition section major axis M₅ may be shorter than the third section 433a major axis M₃. In some examples, the first transition section major axis M₅ may be shorter than the second transition section major axis M₆, and in some examples the first transition section major axis M₅ may be greater than the second transition section major axis M₆.

Various non-limiting exemplary embodiments have been described. It will be appreciated that suitable alternatives are possible without departing from the scope of the examples described herein.

1. A solar tracker row, comprising:
a plurality of A-frame shaped supports coupled to underlying ground, the plurality of A-frame shaped supports arranged in a north-south row, each A-frame shaped support defining a central longitudinal axis;
a torque tube extending along the north-south row and rotatably supported on the plurality of A-frame shaped supports;
a plurality of solar module assemblies coupled to the torque tube;
each A-frame shaped support including at least one tubular, hollow shaft, the hollow shaft having a first section having a first circular cross-section and a second section having a second circular cross-section, the hollow shaft having a third section having an oval cross-section, the oval cross-section defining a major axis and a minor axis, the major axis being oriented in an east-west direction and the minor axis being oriented in the north-south direction, the third section being located between the first section and the second sections, the circular cross-sections and the oval cross-section being taken normal to the central longitudinal axis, the third section providing each A-frame shaped support with greater flexibility in the north-south direction relative to the east-west direction.

2. The solar tracker row of claim 1, wherein the hollow shaft has a first transition section and a second transition section, the first circular cross-section of the first section gradually transitions through the first transition section into the oval cross-section of the third section, and the oval cross-section of the third section gradually transitions through the second transition section into the second circular cross-section of the second section.

3. The solar tracker row of claim 2, wherein the first transition section has an oval cross-section having a first transition section major axis and a first transition minor axis, the first transition section major axis being shorter than the third section major axis.

4. The solar tracker row of claim 2, wherein the first transition section has an oval cross-section having a first transition section major axis and a first transition minor axis, the first transition section minor axis being longer than the third section minor axis.

5. The solar tracker row of claim 1, wherein each A-frame shaped support forms part of a truss, the truss including the A-frame shaped support having the at least one tubular, hollow shaft and a second tubular, hollow shaft embedded in the ground, arranged side-by-side in an east-west orientation, and interconnected by a truss cap.

6. The solar tracker row of claim 1, wherein each A-frame shaped support is formed of at least one ground screw and a hollow upper leg, the first section, second section, and third section being sections of the hollow upper leg.

7. The solar tracker row of claim 1, wherein the third section has a uniform cross-section along the central longitudinal axis.

8. The solar tracker row of claim 1, wherein the third section major axis is larger than a diameter of the first circular cross-section of the first section.

9. The solar tracker row of claim 1, wherein the third section minor axis is shorter than a diameter of the first circular cross-section of the first section.

10. The solar tracker row of claim 1, wherein each A-frame shaped support extends a pier height above the ground, and wherein the third section is located in the upper third portion of the A-frame shaped support.

11. The solar tracker row of claim 1, wherein the first section, second section, and third section together define a flexible section of each A-frame shaped support, wherein each A-frame shaped support contains two or more flexible sections along the central longitudinal axis of each A-frame shaped support.

12. A truss for a solar tracker system comprising:
a first support pier and a second support pier embedded in the ground, arranged side-by-side in an east-west orientation, and interconnected by a truss cap, thereby forming an A-frame shaped support;
wherein the first support pier and the second support pier each include a hollow shaft, the hollow shaft having a first section having a first circular cross-section and a second section having a second circular cross-section, the hollow shaft having a third section having an oval cross-section, the oval cross-section defining a major axis and a minor axis, the major axis being oriented in an east-west direction and the minor axis being oriented in the north-south direction, the third section being located between the first section and the second section, the circular cross-sections and the oval cross-section being taken normal to the central longitudinal axis, the third section providing each support pier with greater flexibility in the north-south direction relative to the east-west direction.

13. The truss of claim 12, wherein the hollow shaft has a first transition section and a second transition section, the first circular cross-section of the first section gradually transitions through the first transition section into the oval cross-section of the third section, and the oval cross-section of the third section gradually transitions through the second transition section into the second circular cross-section of the second section.

14. The truss of claim 12, wherein the first section, second section, and third section together define a flexible section of each support pier, wherein each support pier contains two or more flexible sections along the central longitudinal axis of each support pier.
